(19) United States
(12) Patent Application Publication
(10) Pub. No.: US 2017/0161753 A1
(43) Pub. Date: Jun. 8, 2017

(54) DETECTING WEBSITES ASSOCIATED WITH COUNTERFEIT GOODS

(71) Applicant: COUNTERFY LLC, Boston, MA (US)

(72) Inventors: Daniel J. McKinnon, Boston, MA (US); James P. Gilbert, Waltham, MA (US)

(21) Appl. No.: 15/323,683

(22) PCT Filed: Jun. 4, 2015
(86) PCT No.: PCT/US15/34246

§ 371 Date: Jan. 3, 2017

Related U.S. Application Data
(60) Provisional application No. 62/020,751, filed on Jul. 3, 2014.
(60) Provisional application No. 62/020,761, filed on Jul. 3, 2014.
(60) Provisional application No. 62/020,763, filed on Jul. 3, 2014.

(51) Int. Cl. G06Q 30/00

(52) U.S. Cl. CPC G06Q 30/0185

(57) ABSTRACT

Implementations include actions of receiving a site-analysis request, the site-analysis request including a uniform resource locator (URL) associated with a resource of a website; retrieving the resource based on the URL; identifying content of the resource; performing a plurality of tests based on the content to provide a plurality of results, each test providing a result of the plurality of results; and determining an indicator based on the plurality of results, the indicator indicating a likelihood that the website is selling counterfeit goods.

### BACKGROUND

The continued growth of electronic commerce (e-commerce) through the Internet provides legitimate vendors with a cost-effective alternative to brick-and-mortar stores for selling goods and services. E-commerce websites are also widely considered to be advantageous from the consumer standpoint. However, e-commerce also exposes unwary consumers to vendors selling counterfeit products. Thus, there is a need for techniques to identify counterfeit e-commerce websites.

### SUMMARY

Implementations of the present disclosure include computer-implemented methods for determining a likelihood that a website is selling counterfeit goods, the methods being performed by one or more processors. In some implementations, methods include actions of: receiving, by the one or more processors, a site-analysis request, the site-analysis request including a uniform resource locator (URL) associated with a resource of a website; retrieving, by the one or more processors, the resource based on the URL; identifying, by the one or more processors, content of the resource; performing, by the one or more processors, a plurality of tests based on the content to provide a plurality of results, each test providing a result of the plurality of results; and determining, by the one or more processors, an indicator based on the plurality of results, the indicator indicating a likelihood that the website is selling counterfeit goods. In some implementations, the site-analysis request is received through an application programming interface (API). In some implementations, the site-analysis request is received from a plug-in application to a web browser executing on a client-side computing device

These and other implementations can each optionally include one or more of the following features. In some examples, the request includes a brand name of goods purported to be sold through the resource. In some examples, the resource includes a webpage, and the content includes source code of the webpage.

In some examples, performing the plurality of tests includes performing content-analysis tests including at least one of: a list elements test; a select elements test; a price nodes test; a domain name registry link test; and an email domain test. In some examples, performing the list elements test includes comparing a size of one or more list elements of the resource to a size threshold. In some examples, performing the list elements test includes comparing a position of one or more list elements of the resource to a boundary threshold. In some examples, performing the list elements test includes comparing text of a parent node included in one or more list elements to a search pattern. In some examples, performing the list elements test includes comparing a size of a parent node included in one or more list elements to a child node of the parent node. In some examples, performing the select elements test includes determining if option nodes included in one or more select elements indicate different currencies. In some examples, performing the price nodes test includes the actions of: cataloging price nodes of the resource by class; and determining if two or more classes include the same number of price nodes. In some examples, performing the price nodes test includes the actions of: cataloging price nodes of the resource by price; and determining if a number of distinct prices set forth in the price nodes is less than a predetermined threshold. In some examples, performing the domain name registry link test includes determining if any links of the resource point to a valid domain name registry. In some examples, performing the email domain test includes the actions of: isolating a domain of an email presented at the resource; and determining if the domain of the email corresponds to a domain of the URL included in the request.

In some examples, performing the plurality of tests includes performing URL-analysis tests including at least one of: a secure communications protocol test; and a brand name test. In some examples, performing the secure communications protocol test includes the actions of: making a request to retrieve the resource based on the URL; and determining if the communications protocol used to retrieve the resource is secure. In some examples, performing the secure communications protocol includes the actions of: parsing the URL; and auto-correcting the URL. In some examples, performing the brand name test includes the actions of: isolating a domain of the URL; comparing the domain of the URL to a brand name. In some examples, performing the brand name test further includes determining that the brand name is treated properly in the URL if a text string of the URL domain matches the brand name.

In some examples, determining an indicator based on the plurality of results includes numerically combining the results according to a predetermined formula. In some examples, the predetermined formula includes a plurality of weights, each weight applied to a respective result. In some examples, the plurality of weights of determined based on empirical data.

In some examples, methods further include transmitting a site-analysis response to a source of the site-analysis request, the site-analysis request representative of the indicator.

In some examples, methods further include transmitting instructions to display a user interface, the site-analysis request being received through the user interface. In some examples, the user interface is provided in a webpage. In some examples, methods further include incorporating at least one of the plurality of results and the indicator in a database stored in computer-readable memory.

In some examples, methods further include the actions of: receiving a second site-analysis request; in response to receiving the second site-analysis request, accessing a database stored in computer-readable memory; and determining, based on a second URL included in the second site-analysis request, whether a second indicator indicating a likelihood that a website associated with the secured URL is selling counterfeit goods is incorporated in the database; and in response to determining that the second indicator is incorporated in the database, transmitting a second site-analysis response representative of the second indicator to a source of the second site-analysis request.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system architecture in accordance with implementations of the present disclosure.

FIG. 2 depicts an example site-analysis system.

FIGS. 3-10 depict example processes that can be executed in accordance with implementations of the present disclosure.

### DETAILED DESCRIPTION

Implementations of the present disclosure are generally directed to methods, systems, and computer-readable storage media for determining a likelihood that a website is associated with counterfeit goods. In some implementations, this includes determining whether resources, such as webpages or other types of electronic documents, provided at the website are likely to be selling counterfeit goods. In some implementations, a determination as to whether a webpage is selling counterfeit goods can be made based on content analysis. In some examples, content analysis includes identifying and analyzing content provided at the resource. Content analysis can be accomplished by performing one or more tests on the content and leveraging the results of those tests to provide an indicator. The indicator corresponds to a likelihood that the resource is selling, or is otherwise associated with, counterfeit goods. Content analysis may be initiated in response to a site-analysis request that includes a corresponding uniform resource locator (URL) to identify the resource in question. In some implementations, the URL itself can be examined to provide an indication of whether the webpage is likely to be selling counterfeit goods.

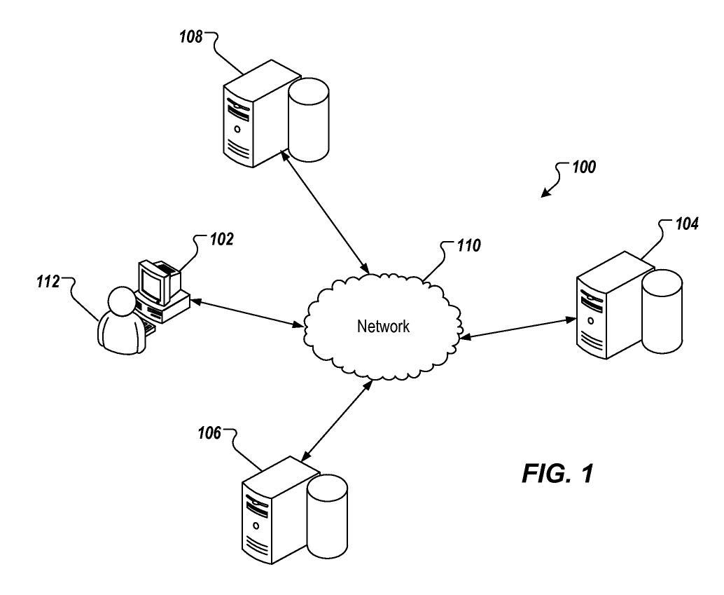

FIG. 1 depicts an example system architecture 100 in accordance with implementations of the present disclosure. The example system architecture 100 includes a client-side computing device (client device) 102, server-side computing devices (server devices) 104, 106, 108 and a network 110. In general, the client device 102 can include any appropriate type of computing device that can communicate with the server devices 104, 106, 108 over the network 110. Example client devices can include a desktop computer, a laptop computer, a handheld computer, a tablet computing device, a personal digital assistant (PDA), a cellular telephone, a network appliance, a camera, a smartphone, an enhanced general packet radio service (EGPRS) mobile phone, a media player, a navigation device, an email device, or any appropriate combination of any two or more of these data processing devices or other data processing devices. In some examples, each of the server devices 104, 106, 108 can represent a server system that can include one or more servers, e.g., a server farm. For example, the server devices 104, 106, 108 can each include one or more computing devices and one or more machine-readable repositories, or databases.

The client device 102 and the server devices 104, 106, 108 can communicate with one another over the network 110. The network 110 can include a large computer network, such as a local area network (LAN), a wide area network (WAN), the Internet, a cellular network, or a combination thereof connecting any number of mobile computing devices, fixed computing devices and server systems.

For purposes of illustration, and as discussed in further detail herein, a user 112 can use the client device 102 to interact with an electronic commerce (e-commerce) enterprise. For example, using the client device 102, the user 112 can view one or more webpages on a website associated with one or more e-commerce enterprises (e-commerce websites). In some examples, an e-commerce enterprise is a retailer that sells goods and/or services using one or more websites. In some examples, an e-commerce website including one or more webpages is hosted on the server device 104. In some examples, interaction between the client device 102 and the server device 104 includes executing a web browser on the client device 102 to display the one or more webpages. For example, the client device 102 can receive one or more documents, e.g., provided in hypertext mark-up language (HTML), and the web browser can process the documents to display the one or more webpages to the user. In some examples, the one or more webpages include interaction elements such as dialogue boxes and clickable buttons that enable the user 112 to provide input to the webpage. For example, the user 112 can select items for purchase and can provide payment information through the webpage.

In some implementations, the server device 106 can be associated with a payment provider. Example payment providers can include a credit card company and a bank. In some examples, an authorization request can be submitted to the server device to authorize payment for goods and/or services. For example, the user 112 can submit payment information, e.g. credit card information, to an e-commerce website hosted on the server device 104. The server device 104 can transmit an authorization request to the server device 106. In some examples, the authorization request includes the payment information, e.g., account number, expiration date, security code, an amount to be authorized, and a uniform resource locator (URL) associated with the requesting website. The server device 106 processes the authorization request and provides a response. For example, the response can include a payment authorization, e.g., including an authorization code. As another example, the response can include a payment denial.

In some implementations, the server device 108 can provide access to a site-analysis system. As will be described in detail below, the site-analysis system is operable to determine whether a website, e.g., an e-commerce website hosted on the server device 104, is likely to be associated with counterfeit goods. As one example, the site-analysis system can perform one or more tests based on content available through one or more webpages of the e-commerce website to provide an indicator corresponding to a likelihood that a webpage on the website is selling counterfeit goods.

In some implementations, the user 112 can interact with the site-analysis system through the web browser. For example, the user 112 can open a webpage associated with the site-analysis system, e.g., a webpage hosted on the server device 108, and input a URL associated with an e-commerce webpage, through which the user 112 is intending to purchase goods and/or services. The site-analysis system receives the URL through the webpage at the server device 108, performs tests on the e-commerce webpage corresponding to the URL, and provides an indication as to whether the URL is associated with counterfeit goods.

In some implementations, the server device 106 can interact with the site-analysis system. In some examples, the site-analysis system can expose an application programming interface (API), through which site-analysis requests can be received, and site-analysis responses can be provided. For example, the server device 106 can receive an authorization request, e.g., from the server device 104, the payment authorization request including a URL corresponding to a webpage, through which the user 112 is intending to purchase products (e.g., goods and/or services). In response, the server device 106 can send a site-analysis request to the server device 108, i.e., to the site-analysis system, through an API, the site-analysis request including the URL. The site-analysis system receives the URL, performs tests on the e-commerce webpage corresponding to the URL, and provides an indication as to whether the URL is associated with counterfeit goods. For example, the indication can be provided in a site-analysis response provided to the server device 106 through the API. In some examples, the server device 106 can make a payment authorization decision, at least partially based on the indication. For example, if the indication is that the e-commerce webpage is likely selling counterfeit goods, the payment authorization request can be denied.

In some implementations, a web browser executed on the client device 102 can interact with the site-analysis system. In some examples, a plug-in can be provided for the web browser, and can automatically send a site-analysis request in response to a webpage being displayed in the web browser, the site-analysis request including the URL. The site-analysis system receives the URL, performs tests on the e-commerce webpage corresponding to the URL, and provides an indication as to whether the URL is associated with counterfeit goods. For example, the indication can be provided in a site-analysis response provided to the browser plug-in. In some examples, the web browser can alert the user 112 based on the indication. For example, if the indication is that the e-commerce webpage is likely selling counterfeit goods, a visual and/or audible alert can be provided to the user 112.

As introduced above, implementations of the present disclosure are generally directed to methods, systems, and computer-readable storage media for determining a likelihood that a website is associated with counterfeit goods. In some implementations, this determination is made in response to receiving a site-analysis request. The request may be received, e.g., through a user interface, through a plug-in application to a web browser, or through an API. In some implementations, the request includes a URL associated with a webpage of the website in question. Thus, the webpage can be retrieved based on the URL, and evaluated to determine whether the website as a whole is likely to be associated with counterfeit goods.

In some implementations, the webpage can be evaluated to determine whether it is likely to be selling counterfeit goods by identifying and analyzing content provided at the webpage. In some examples, content at other webpages linked to the requested webpage at the website is also identified and analyzed. In some examples, “content” includes any form of digital data that can be associated with a resource. Thus, “content” can include textual, visual, and/or aural content such as may be presented to a user through a user interface, as well as source code (e.g., PHP, HTML, XHTML, Java, JavaScript) that defines the structure of other content provided at the resource.

Identifying webpage content can include in-situ parsing of the content at its original location and/or extracting or “scraping” the content from the webpage to provide a local copy. In some examples, a web crawler is provided to expand the content analysis from the requested webpage to other webpages at the website. The requested webpage can provide the seed for the web crawler, and links to one or more other webpages at the website provide the web crawler's frontier.

Content analysis can produce an indicator corresponding to a likelihood that the webpage is selling counterfeit goods. In some implementations, the content analysis includes performing one or more tests based on the content and leveraging the results of those tests to provide the indicator. The content analysis-tests may involve scrutinizing the content to identify certain characteristics that are common or uncommon amongst counterfeit e-commerce websites. Thus, as counterfeit e-commerce websites change over time, the content-analysis tests and techniques for generating the indicator based on test results may be modified or altered with departing from the scope of the present disclosure. For at least this reason, the specific examples provided herein are not intended to be limiting.

In some implementations, the content-analysis tests involve identifying certain types of list elements in the content (e.g., ordered or unordered lists) that are common amongst counterfeit e-commerce websites. In some examples, identifying a suspicious list element includes examining the size and position of the list element and/or the text of one or more parent nodes included in the list element. In some implementations, the content-analysis tests involve identifying certain types of select elements in the content (e.g., drop-down list) that are common amongst counterfeit e-commerce websites. In some examples, identifying a suspicious select element includes examining the text of one or more option nodes included in the select element. In some implementations, the content-analysis tests involve identifying elements having classes of similar price nodes (e.g., price nodes with similar price-indicating text). In some implementations, the content-analysis tests involve identifying certain types of links, such as links to domain name registries. In some implementations, the content-analysis tests involve identifying nodes including email addresses, and determining whether the email addresses are likely to be associated with a non-counterfeit (valid) resource. In some examples, valid email addresses include a domain that is sufficiently similar to the URL corresponding to the resource.

In some implementations, content analysis includes a combination of multiple tests distributed across various aspects of the webpage. The individual results of the multiple tests can be merged to provide the indicator. The test results may include binary (e.g., yes/no, true/false, I/O) or numerical (e.g., 1, 2.5, 5) test results. In some examples, the test results (binary or numerical) can be aggregated to provide a numerical indicator. The magnitude of the indicator can be compared to one or more predetermined threshold values to determine whether the webpage is likely selling counterfeit goods. In some examples, the test results can be combined using a weighted mathematical formula, where a weight applied to each test result corresponds to the strength or sensitivity of the test. The weights may be determined empirically or theoretically. In some examples, machine learning or other statistical techniques can be used to empirically determine the weights based on various aspects of known counterfeit e-commerce websites.

In some implementations, a webpage can be evaluated to determine whether it is likely to be selling counterfeit goods by analyzing its corresponding URL. In some implementations, tests for examining a URL involve determining whether a communications protocol included in the URL is secured against attacks and/or surveillance by a third parties. In some implementations, the URL-analysis tests involve determining whether a brand name associated with goods for sell through the webpage (which may be included in the request) is used in the URL, and scrutinizing the usage of the brand name (e.g., determining whether the brand name is treated properly in the URL). Results from the URL-analysis tests can be combined with the content-analysis tests, or used to provide a separate indicator.

One or more test results and/or indicators based content-analysis or URL-analysis tests can be stored in computer-readable memory for future use. In some examples, a database associating test results and/or indicators, as well as other details of the site analysis (e.g., date and time of the tests), with corresponding URLs can be maintained for use with future site-analysis requests. For example, if the request includes a URL that has already been sufficiently analyzed, the test results and/or indicators in the database can be used to answer the request.

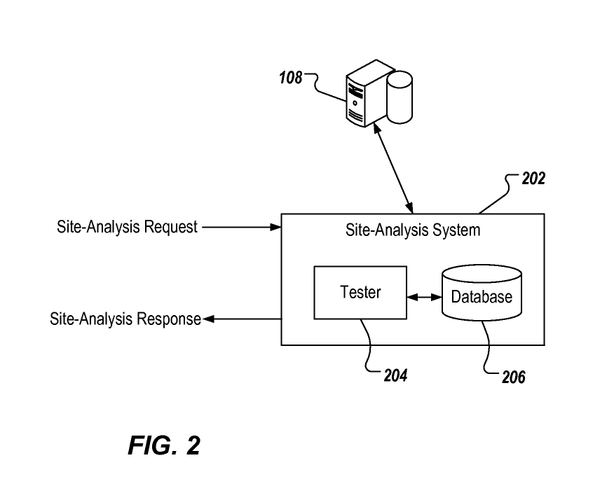

FIG. 2 depicts an example site-analysis system 202 accessible through the server device 108. The site-analysis system 202 includes a tester 204 and a database 206. In response to receiving a site-analysis request through the server device 108, the tester 204 initiates a programmed routine for evaluating an e-commerce website referenced in the request. A site-analysis response indicating a likelihood that the e-commerce website is associated with counterfeit goods is provided to the source of the request.

In some implementations, the evaluation routine executed by the tester 204 includes accessing the database 206 to determine whether the e-commerce website referenced in the request has already been tested. If relevant test results and/or indicators are saved in the database, they may be used to provide the site-analysis response. For example, the database may contain lists of “whitelisted” and “blacklisted” websites that can be referenced to provide the site-analysis response. Otherwise, the tester 204 evaluates the e-commerce website by: retrieving one or more pages of the website; implementing one or more tests on the content of the webpage(s) and/or on the URL of the webpage(s); and generating an indicator corresponding to a likelihood that one or more of the webpages a selling counterfeit goods. The indicator is then used to provide the site-analysis response. In some examples, the tester 204 may determine that the stored test results and/or indicators corresponding to the e-commerce website referenced in the request are out of date or inconclusive. In this case, the tester 204 may commence with evaluating the website to update the database 206.

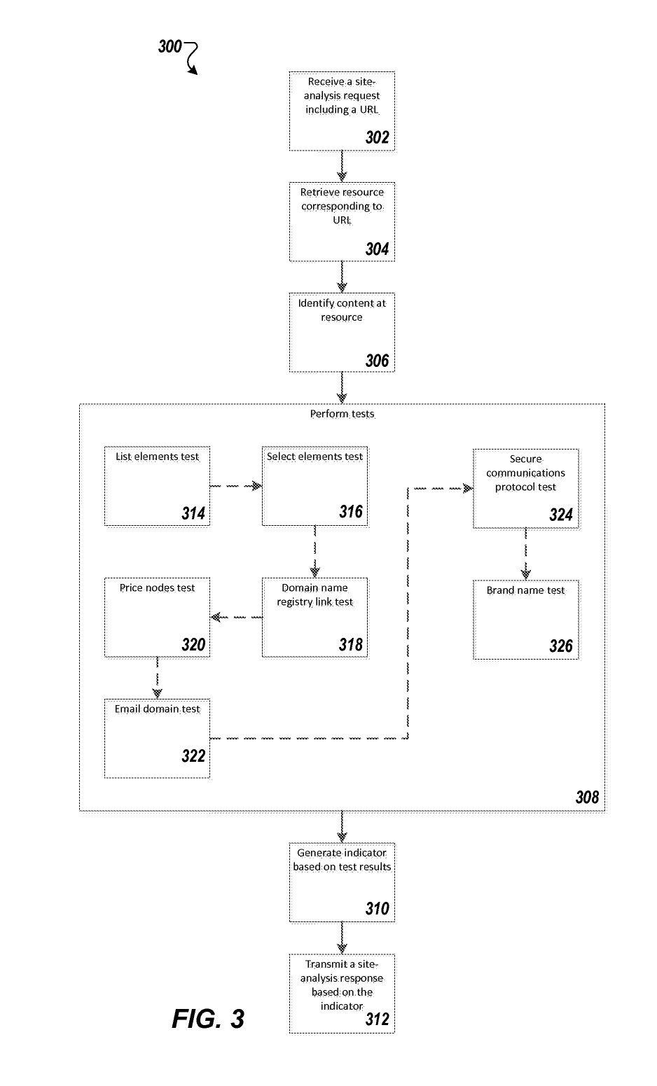

FIG. 3 depicts an example process 300 that can be executed in accordance with implementations of the present disclosure. In some implementations, the example process 300 can be realized using one or more computer-executable programs (e.g., a browser, a web application, a mobile application) executed using one or more computing devices (e.g., a client device, a server device).

According to the process 300, a site-analysis request including a URL is received (302). In some implementations, the site-analysis request sent via a plug-in application, through a user interface, or through an API. In some examples, a resource, e.g., a webpage, is retrieved using the URL (304). Content at the retrieved resource can identified (306). For example, content at the resource can be in-situ parsed or scraped from the resource. In some examples, one or more tests are performed to evaluate the resource (308). An indicator indicating whether the resource is likely selling counterfeit goods can be provided based on results from the one or more tests (310). In some implementations, the indicator is a numerical value determined by combining the results of multiple tests. In some examples, a site-analysis response based on the indicator can be transmitted, e.g., to a source of the site-analysis request (312). The site-analysis request provides an indication as to whether an e-commerce website referenced by the URL in the request is associated with counterfeit goods. The site-analysis response may include the indicator itself or a textual, graphical, or aural representation of the indicator. For example, if the indicator is determined to be above a predetermined threshold, the site-analysis response may simply include a text string stating that the e-commerce website is likely associated with counterfeit goods (e.g., “We suspect this webpage is selling counterfeit goods.”).

In some implementations, the process 300 can be modified based on server-load. For example, different combinations of tests may be performed based on server load. So, during a time at high server-load a lesser number of tests and/or a particular combination of less intensive tests may be performed as compared to a time at low server load. Similarly, in some implementations, if the resource cannot be retrieved within a predetermined amount of time (e.g., X number of seconds), then the site-analysis request may time out, and an automated response can be sent to the source of the request.

Suitable tests that can be performed to evaluate the resource include content-analysis tests including: a list elements test (314), a select elements test (316), a domain name registry link test (318), a price nodes test (320), and an email domain test (322). Suitable tests that can be performed further include URL-analysis tests including: a secure communications protocol test (324) and a brand name test (326). The aforementioned tests will be described in detail below. However, it is contemplated that any additional tests suitable for evaluating whether a resource is likely associated with counterfeit goods may be used without departing from the scope of the present disclosure. Further, it is contemplated that any one of the listed tests or a sub-combination of the tests may be selected. Further still, it is contemplated, that the tests may be modified over time to account for new and changing tendencies among counterfeit e-commerce websites.

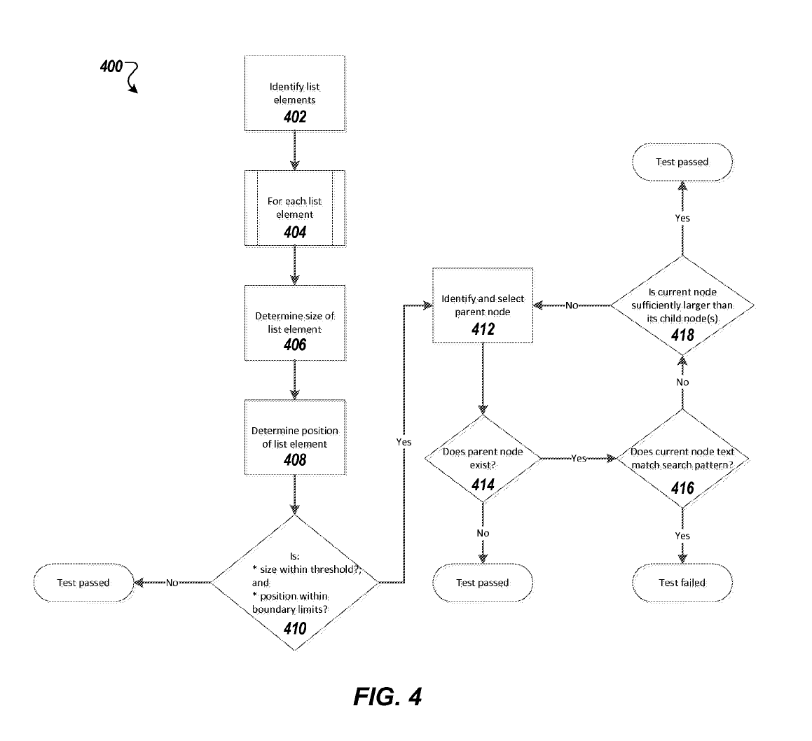

FIGS. 4-10 are flow charts illustrating example processes for implementing tests to evaluate a resource with respect to a likelihood that the resource is selling counterfeit goods. A passed test suggests that the resource is not selling counterfeit goods; and a failed test suggests the opposite. As noted above, one or more tests can be implemented by the tester 204 of the site analysis system 202. Further, while the following tests are described in context of a webpage defined by web-based source code organized in a syntax tree data structure, the present disclosure is not so limited. Thus, it is contemplated within the scope of the present disclosure one or more tests could be applied to any suitable type of electronic document (e.g., a Rich Text Format (RTF) document or a Portable Document Format (PDF) document).

FIG. 4 depicts an example process 400 for implementing a list elements test included in content analysis of a webpage. This test is aimed at comparing certain aspects of list elements incorporated in a requested webpage to defining aspects of list elements that are incorporated in webpages known to sell counterfeit goods. As one particular example, the list elements test can be focused on identifying long lists of products under a generic heading (e.g., “Categories” or “Items”) that is positioned near the left edge of the screen.

According to the process 400, the list elements of the webpage are identified (402). In some implementations, the following logic flow is executed for each list element (404). The size of the list element can be determined (406). For example, the height and width properties of the list element in terms of screen pixels can be ascertained. The position of the list element can be determined (408). For example, one or more absolute position properties of the list element in terms of screen pixels can be ascertained. In some examples, it is determined whether the size of the list element is greater than a predetermined threshold (e.g., Is the height/width of the list element greater than X pixels, where X is any predetermined number of pixels?) and whether the position is within one or more predetermined boundary limits (e.g., Is the list element position within a distance X pixels of the left screen edge, where X is any predetermined number of pixels?) (410). If both the list-element size and position satisfy the respective threshold conditions, the logic flow continues. Otherwise the test is passed because the list element is not suspiciously or positioned in a suspicious area of the screen.

The following portion of the logic flow is aimed at identifying and analyzing a header of the list element. In some examples, a parent node of the list element is identified and selected (412). If there are no parent nodes (e.g., if all list items are at the same tree level), the test is passed because the list element does not contain a header (414). Otherwise, if the text of the selected parent node matches a predetermined generic-term search pattern, the test is failed because a potential header of the list element is a generic term (416). Otherwise, if the selected parent node is sufficiently larger in screen size than its child node(s), the test is passed because a likely header of the list element is not a generic term (418). Otherwise, the logic flow repeats, and the next parent node is identified and selected. The test is passed if/when all parent nodes have been examined without a text match to the generic-term search pattern.

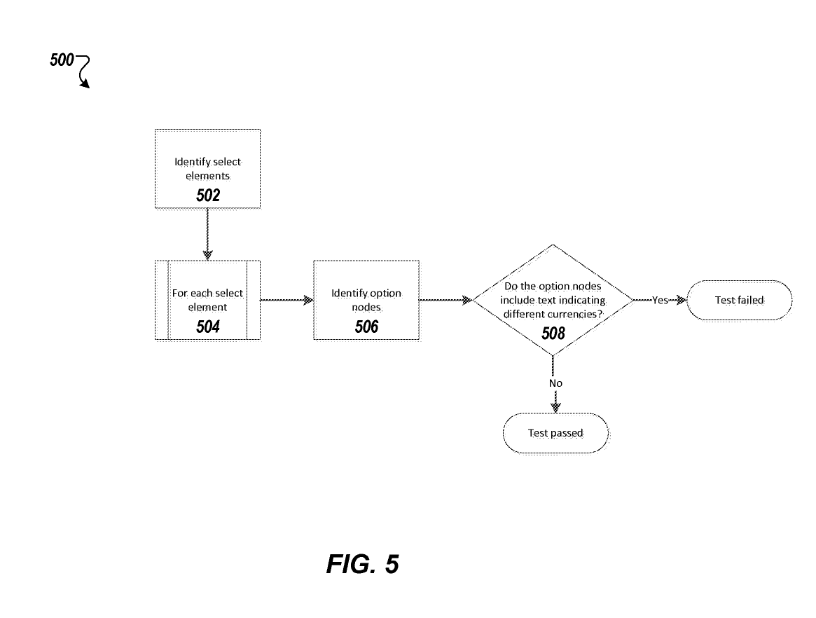

FIG. 5 depicts an example process 500 for implementing a select elements test included in content analysis of a webpage. This test is aimed at comparing certain aspects of select elements incorporated in the requested webpage to defining aspects of select elements that are incorporated in webpages known to sell counterfeit goods. As one example, the select elements test can be focused on identifying select elements for offering payment in multiple currencies.

According to the process 500, the select elements (e.g., drop-down lists) of the webpage can be identified (502). In some implementations, the following logic flow is executed for each select element (504). The option nodes of the select item (e.g., the selectable options of the drop down list) can be identified (506). In some examples, if the option nodes include text indicating different types of currencies (e.g., U.S. dollars and Chinese Yen), the test is failed (508). Otherwise, the test is passed. In some examples, the select elements test can be focused to identify select elements that offer more than a predetermined number of currency options. In some examples, the select elements test can be focused to identify select elements that offer certain combinations of currency options.

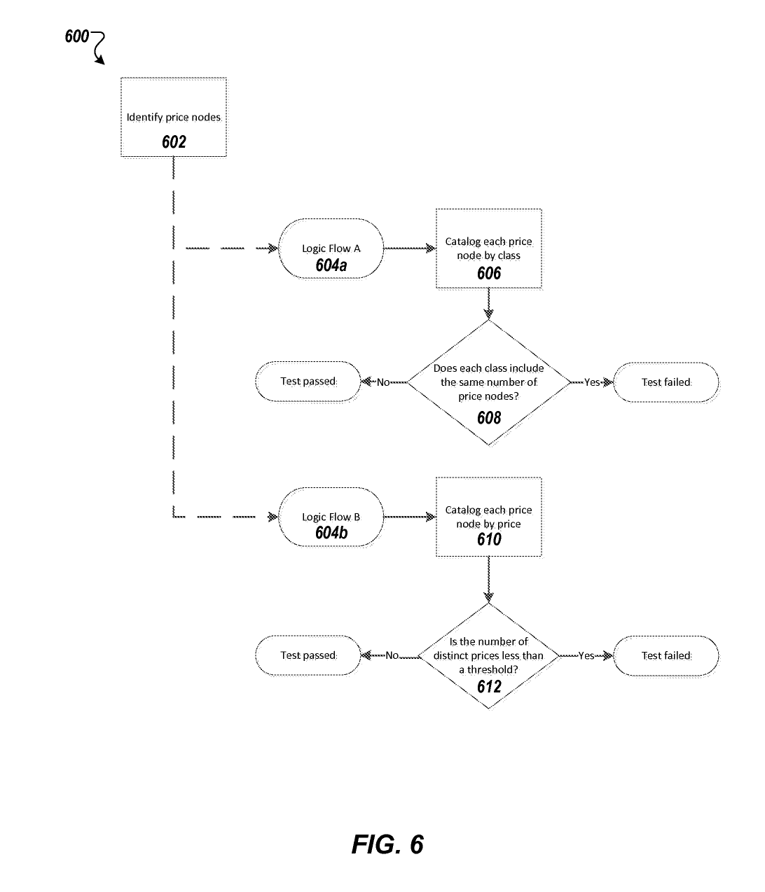

FIG. 6 depicts an example process 600 for implementing a price nodes test included in content analysis of a webpage. This test is aimed at detecting whether the webpage is displaying long lists of products that are all discounted and/or whether the webpage is displaying long lists of products that are all offered for sale at the same price.

According to the process 600, the price nodes of the webpage can be identified (602). In some examples, the price nodes can be recognized as any nodes including text suggestive of a price, e.g., numbers, currency signs, percentage signs. In some implementations, either (or both) of Logic Flow A (604a) and Logic Flow B (604b) can be executed. According to Logic Flow A, the price nodes can be cataloged by class (606). In some examples, if each class of price nodes includes the same number of price nodes, the test is failed; otherwise, the test is passed (608). Multiple (e.g., two or more) classes including the same number of price nodes suggests that a collection of products are all discounted. For example, a first class may list the original price of each product, a second class may list the discounted price of each product, and a third class may list the percentage of the discount for each product. In some examples, only classes having a predetermined number of price nodes are inspected.

According to Logic Flow B, the price nodes can be cataloged by price (610). In some examples, if the number of distinct prices set forth in the price nodes is less than a predetermined threshold, the test is failed; otherwise, the test is passed (612). Multiple price nodes indicating the same price indicates that a collection of products are being sold for equal value. In some examples, the threshold number of distinct prices set forth in the price nodes varies with respect to the total number of price nodes. So, when a low number of price nodes (e.g., ten or less) the threshold may be set to one; and with a high number of price nodes (e.g., thirty or more), the threshold may be set to three.

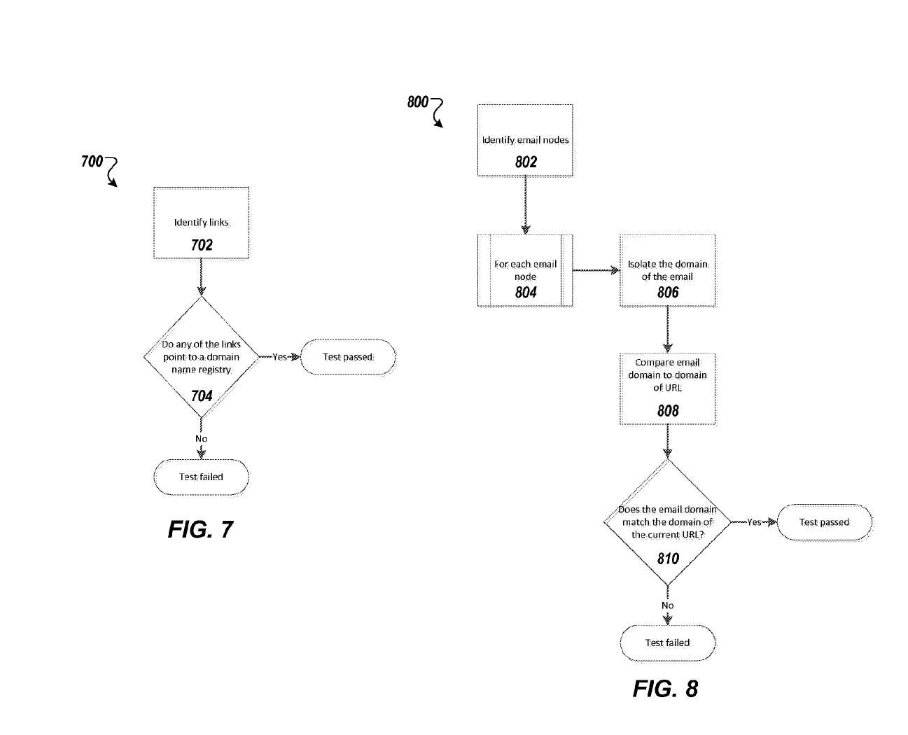

FIG. 7 depicts an example process 700 for implementing a domain name registry link test included in content analysis of a webpage. Some counterfeit e-commerce webpages attempt to provide a false sense of security by creating fake links or logos associated with domain name registries. This test is aimed at identifying valid associations between the webpage and a recognized domain name registry. According to the process 700, the links of the webpage can be identified (702). In some examples, if any of the links point to a recognized domain name registry (e.g., Verisign), then the test is passed; otherwise, the test is failed (704).

FIG. 8 depicts an example process 800 for implementing an email domain test included in content analysis of a webpage. Many counterfeit e-commerce websites are designed at minimal cost, and therefore use generic email domains for contact addresses. Thus, this test is aimed at identifying webpages that present a contact email address without a unique domain related to the URL. According to the process 800, the email nodes of the webpage can be identified (802). In some examples, email nodes can be recognized as any nodes including text suggestive of an email address, such as an “@” symbol or recognizable domain. In some implementations, the following logic flow is executed for each email node (804). In some examples, the domain of the email is isolated (806). For example, the email address john.doe@example.com can be stripped of the local part “john.doe” and the top-level domain “.com” to isolate the domain “example”. The domain of the email node can be compared to the domain of the URL received in the request (808). For example, the domain of “https://www.example.com” would be “example”. In some examples, if the email domain sufficiently matches the domain of the URL, the test is passed; otherwise, the test is failed (810).

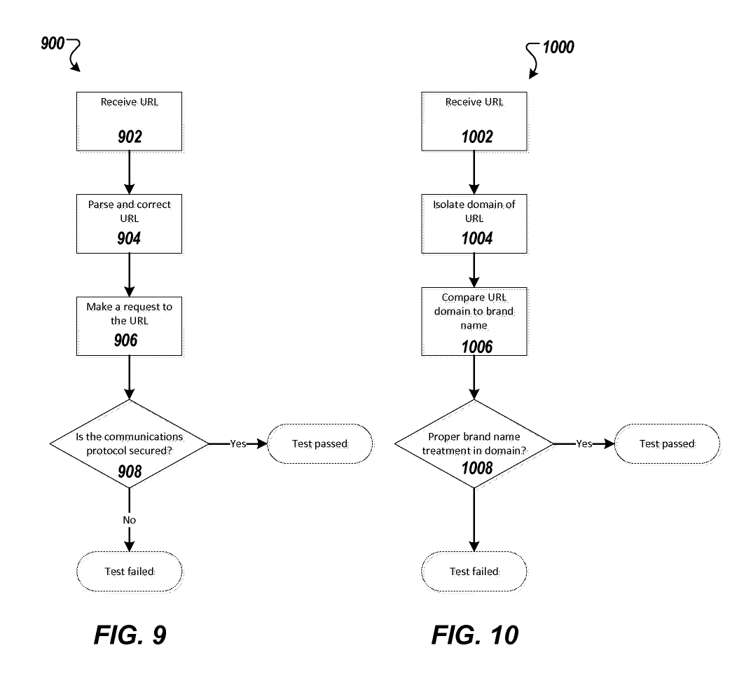

FIG. 9 depicts an example process 900 for implementing a secure communications protocol test included in URL analysis of a webpage. As noted above, many counterfeit e-commerce websites are designed at minimal cost. Therefore, to save on costs, URLs to webpages on the site are unlikely to utilize a secured communications protocol (e.g., HTTPS). Thus, this test is aimed at identifying webpages that fail to employ secured communications protocols in the corresponding URL. According to the process 900, the URL is received from a site-analysis request (902). In some examples, the URL is parsed and corrected (904), for example, to cure detectable typographical errors and/or to add a protocol resource tag. A request can be made to access the webpage at the corrected URL (906). In some examples, if the communications protocol used to retrieve the webpage at the URL is secured, the test is passed (908). Otherwise, the test is failed.

FIG. 10 depicts an example process 1000 for implementing a brand name test included in URL analysis of a webpage. Because most URLs incorporating well-known brand names are controlled by legitimate owners and distributors, many counterfeit e-commerce websites are forced to use a confusingly similar version of the brand name in the URL. Thus, this test is aimed at identifying webpages that use improper brand name treatment in the URL. According to the process 1000, the URL can be received from a site-analysis request (1002). The domain of the URL can be isolated (1004), for example, using the techniques described above. The domain of the URL can be compared to a purported brand name of the products for sale through the webpage (1006). In some examples, the purported brand name is included in the request. In some examples, if the brand name is treated properly, the test is passed (1008). Otherwise, the test is failed. Thresholds and parameters for testing brand name treatment can vary between different implementations. In some implementations, proper brand name treatment is achieved if the text in the URL domain spells out the brand name correctly, irrespective of any periods, dashes, or underscores. In some implementations, proper brand name treatment is achieved only if text in the URL domain exactly matches the brand name.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for determining a likelihood that a website is selling counterfeit goods, the method being executed using one or more processors and comprising:
receiving, by the one or more processors, a site-analysis request, the site-analysis request comprising a uniform resource locator (URL) associated with a resource of a website;
retrieving, by the one or more processors, the resource based on the URL;
identifying, by the one or more processors, content of the resource;
performing, by the one or more processors, a plurality of tests based on the content to provide a plurality of results, each test providing a result of the plurality of results; and
determining, by the one or more processors, an indicator based on the plurality of results, the indicator indicating a likelihood that the website is selling counterfeit goods.

2. The method of claim 1, wherein the request includes a brand name of goods purported to be sold through the resource.

3. The method of claim 1, wherein the resource comprises a webpage, and wherein the content comprises source code of the webpage.

4. The method of claim 1, wherein performing the plurality of tests comprises performing content-analysis tests including at least one of:
a list elements test;
a select elements test;
a price nodes test;
a domain name registry link test; and
an email domain test.

5. The method of claim 4, wherein performing the list elements test comprises comparing a size of one or more list elements of the resource to a size threshold.

6. The method of claim 4, wherein performing the list elements test comprises comparing a position of one or more list elements of the resource to a boundary threshold.

7. The method of claim 4, wherein performing the list elements test comprises comparing text of a parent node included in one or more list elements to a search pattern.

8. The method of claim 4, wherein performing the list elements test comprises comparing a size of a parent node included in one or more list elements to a child node of the parent node.

9. The method of claim 4, wherein performing the select elements test comprises determining if option nodes included in one or more select elements indicate different currencies.

10. The method of claim 4, wherein performing the price nodes test comprises:
cataloging price nodes of the resource by class; and
determining if two or more classes include the same number of price nodes.

11. The method of claim 4, wherein performing the price nodes test comprises:
cataloging price nodes of the resource by price; and
determining if a number of distinct prices set forth in the price nodes is less than a predetermined threshold.

12. The method of claim 4, wherein performing the domain name registry link test comprises determining if any links of the resource point to a valid domain name registry.

13. The method of claim 4, wherein performing the email domain test comprises:
isolating a domain of an email presented at the resource; and
determining if the domain of the email corresponds to a domain of the URL included in the request.

14. The method of claim 1, wherein performing the plurality of tests comprises performing URL-analysis tests including at least one of:
a secure communications protocol test; and
a brand name test.

15. The method of claim 14, wherein performing the secure communications protocol test comprises:
making a request to retrieve the resource based on the URL; and
determining if the communications protocol used to retrieve the resource is secure.

16. The method of claim 14, wherein performing the secure communications protocol comprises:
parsing the URL; and
auto-correcting the URL.

17. The method of claim 14, wherein performing the brand name test comprises:
isolating a domain of the URL;
comparing the domain of the URL to a brand name.

18. The method of claim 17, wherein performing the brand name test further comprises determining that the brand name is treated properly in the URL if a text string of the URL domain matches the brand name.

19.-26. (canceled)

27. A non-transitory computer-readable storage medium coupled to one or more processors and having instructions stored thereon which, when executed by the one or more processors, cause the one or more processors to perform operations for determining a likelihood that a website is selling counterfeit goods, the operations comprising:
receiving, by the one or more processors, a site-analysis request, the site-analysis request comprising a uniform resource locator (URL) associated with a resource of a website;
retrieving, by the one or more processors, the resource based on the URL;
identifying, by the one or more processors, content of the resource;
performing, by the one or more processors, a plurality of tests based on the content to provide a plurality of results, each test providing a result of the plurality of results; and
determining, by the one or more processors, an indicator based on the plurality of results, the indicator indicating a likelihood that the website is selling counterfeit goods.

28.-52. (canceled)

53. A system, comprising:
a computing device; and
a computer-readable storage device coupled to the computing device and having instructions stored thereon which, when executed by the computing device, cause the computing device to perform operations for determining a likelihood that a website is selling counterfeit goods, the operations comprising:
receiving a site-analysis request, the site-analysis request comprising a uniform resource locator (URL) associated with a resource of a web site;
retrieving the resource based on the URL;
identifying content of the resource;
performing plurality of tests based on the content to provide a plurality of results, each test providing a result of the plurality of results; and
determining an indicator based on the plurality of results, the indicator indicating a likelihood that the website is selling counterfeit goods.

54.-78. (canceled)
